(19) United States
(12) Patent Application Publication
(10) Pub. No.: US 2005/0008006 A1
(43) Pub. Date: Jan. 13, 2005

(54) Method for operating a voice terminal connected to a remote private automatic branch exchange, communication arrangement and voice terminal

(76) Inventor: Thomas Schimper, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/884,635

(22) Filed: Jul. 2, 2004

(30) Foreign Application Priority Data
Jul. 2, 2003 (DE) 10329877.0

(51) Int. Cl. H04L 12/66; H04L 12/28; H04L 12/56

(52) U.S. Cl. 370/352; 370/401

(57) ABSTRACT

Method for operating a voice terminal connected to a remote private automatic branch exchange, communication arrangement, and voice terminal The present invention relates to a method and a communication arrangement for operating a VoIP voice terminal connected to a remote IP private automatic branch exchange, for example Centrex or hosted PBX, with there being a VPN connection between the VoIP voice terminal and the network of the carrier of the remote private automatic branch exchange and with communication between the voice terminal and the remote private automatic branch exchange taking place via said VPN connection. Problems arising during NAT translation when the voice terminal is located in a local network whose IP addresses are not valid in the carrier network are advantageously avoided thereby.

Method for operating a voice terminal connected to a remote private automatic branch exchange, communication arrangement, and voice terminal

The Centrex service (Central Office Exchange Service) is an IN value-added service in the voice domain, known from classical communication networks, which is offered by independent network carriers and which generates substantial savings potential among corporate users. The Centrex service can be regarded as a kind of external relocation of services with the local carrier switching additional features to the relevant corporate user via the local switching center. The carrier makes all the call processing systems necessary for telephony available to the corporate users. Said users consequently do not require a separate telephone infrastructure of their own; all offered value-added services are provided by the network carrier. There are only telephony terminals on the corporate user's premises.

A similar service is known in the form of a hosted PBX (in full: hosted private automatic branch exchange). The private automatic branch exchange, together with the requisite maintenance, is here passed over to a service provider external to the corporate user, with said provider then providing the hosting service.

The Centrex and hosted PBX services are also referred to below in summary form as a remote private automatic branch exchange.

From the corporate user's viewpoint, the advantages are the same as those obtained from using the Centrex service. The distinction from the network viewpoint is that Centrex is offered by the operator of the telephone network and implemented in the operator's public switching centers, whereas the hosted PBX service involves a real private automatic branch exchange operated by a third party and located between the corporate user and public telephone network.

As part of the process of standardizing and simplifying hitherto heterogeneous corporate networks, increasing use is being made of Internet Protocol-based (IP-based) telephony terminals; these do away with the need to install and maintain a separate telephony network as the data network installed in any event for modern workplaces can also be used for voice services.

In conjunction with the Centrex or hosted PBX services, IP-based telephony terminals give rise to various problems.

One of said problems relates to the issuing of IP addresses. IP addresses are regularly issued by the corporate user's IT service providers or/and Internet Service Provider (ISP) for every connected terminal, and thus for every connected IP telephone. The ISP is generally different from the telephony service provider and the IP addresses are issued internally within the company by, for example, the IT service provider. The IP address of the telephony terminals must be known to the Centrex switching center or the hosted PBX providing the voice telephony service by means of Voice-over-IP.

The addresses of all IP terminals, in particular those of IP telephones, will usually change if there is a change within the company in, for example, the scheme for issuing IP addresses as a result of, say, changing from one ISP to another. Said change must then likewise be adopted by the operator of the Centrex or hosted PBX in the databases of the Centrex or hosted PBX. As this involves substantial administrative effort, it has hitherto been common practice for the Centrex or hosted PBX services to be provided by a service provider also performing the functions of the ISP.

A further problem arises from the fact that corporate networks are always safeguarded from their external environment, which is to say from the internet and also from other IP networks, by means of, for example, what are termed firewalls. Said networks are frequently also safeguarded from the IP telephony service provider's public switching network. Firewalls restrict IP traffic between the internal IP network and external IP network(s).

Alongside traffic restriction, address conversion is usually also carried out in order, for example, to counteract address space limitations. By means of the Network Address Translation (NAT) method, the internal IP network is able to store far more internal than externally known IP addresses and devices. A NAT firewall is then provided which monitors internal-to-external connections and in each case replaces the internal addresses with a specific number of external addresses. In this way it is possible to convert a large number of internal addresses into a single external address.

Address conversion gives rise to a problem, however, namely that unless special precautions are taken, known VoIP protocols such as H.323, SIP, and MGCP/Megaco are unsuitable for use in conjunction with NAT firewalls because these protocols operate using local IP addresses and transport corresponding references which are not translated on the path via the NAT firewall, meaning that VoIP connections cannot be set up over NAT firewalls.

The object of the present invention is accordingly to describe a method for operating a voice terminal connected to a remote private automatic branch exchange, a communication arrangement, and a voice terminal by means of which the cited problems are avoided.

Said object is achieved by means of the features of the independent claims. Preferred embodiments are given in the dependent claims.

According to the invention, a method for operating a voice terminal connected to a remote private automatic branch exchange is provided in which
communication between the voice terminal and remote private automatic branch exchange takes place using the Internet Protocol,
the voice terminal is assigned to a subnetwork having a first IP address space and the remote private automatic branch exchange operates in a second IP address space, and
IP addresses of the first IP address space are not valid in the second IP address space
   having the following steps:
a) determining an IP address from the first address space for the voice terminal,
b) determining a VPN server for the voice terminal,
c) setting up a VPN connection between the voice terminal and VPN server with assigning of a further IP address, taken from the second IP address space, by the VPN server, and
d) exchanging useful information and/or signaling information between the voice terminal and remote private automatic branch exchange via the VPN connection by means of the VPN server.

A communication arrangement having a voice terminal and a remote private automatic branch exchange is further provided in which
communication between the voice terminal and remote private automatic branch exchange takes place using the Internet Protocol,
the voice terminal is assigned to a subnetwork having a first IP address space and the remote private automatic branch exchange is assigned to a network having a second IP address space, and
IP addresses of the first IP address space are not valid in the second IP address space,
   said arrangement being distinguished by the existence of a VPN connection between the voice terminal and the network to which the remote private automatic branch exchange is assigned and the fact that communication between the voice terminal and remote private automatic branch exchange takes place via said VPN connection.

The invention finally provides a novel type of voice terminal for use in conjunction with the communication arrangement
having means for transmitting and receiving useful information and signaling information using the IP Internet Protocol,
having means for receiving an own IP address of a first IP address space,
having means for carrying out IP communication employing the own IP address of the first address space,
having means for determining an IP address of a VPN server,
having means for setting up a VPN connection to the VPN server, and
having means for receiving a further own IP address from a second IP address space and an IP address of the remote private automatic branch exchange.

A major advantage of the invention is that the VPN connection avoids the disadvantages cited at the beginning. Assignment of the further IP address for the voice terminal from the second IP address space, to which the remote private automatic branch exchange is also assigned, in particular ensures that communication with the remote private automatic branch exchange can take place independently of the issuing of addresses in the local corporate subnetwork.

A further effect of the VPN connection is that communication between the remote private automatic branch exchange and the voice terminal is routed through the corporate network transparently, which is to say as though the voice terminal were connected directly to the remote private automatic branch exchange, with communication being hindered as little by address conversion by NAT servers as by traffic restrictions due to firewalls and other security devices.

The invention also advantageously allows voice terminals to be installed and relocated simply. The administration effort previously involved in maintaining the databases for assigning the voice terminal's local IP address to the directory number, and the like, is rendered superfluous.

The invention advantageously enables IP-based remote private automatic branch exchanges such as Centrex and hosted PBX to be introduced into corporate networks as only two requirements have to be met: the VPN server must be accessible from the corporate network and existing firewalls must allow the unimpeded passage of traffic to and from said VPN server. This can be implemented in existing corporate networks with minimal effort and will put an end to the previously rigid coupling of the various service providers in the corporate network.

The invention is described below as an exemplary embodiment in conjunction with 2 drawings.

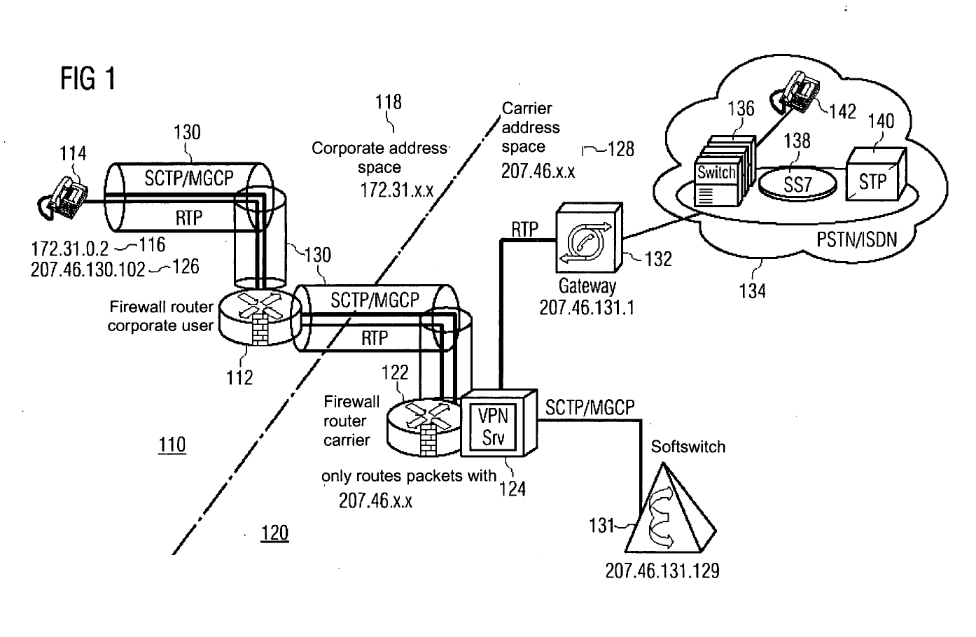

FIG. 1 shows the communication arrangement according to the invention with a VPN connection between the voice terminal and carrier network.

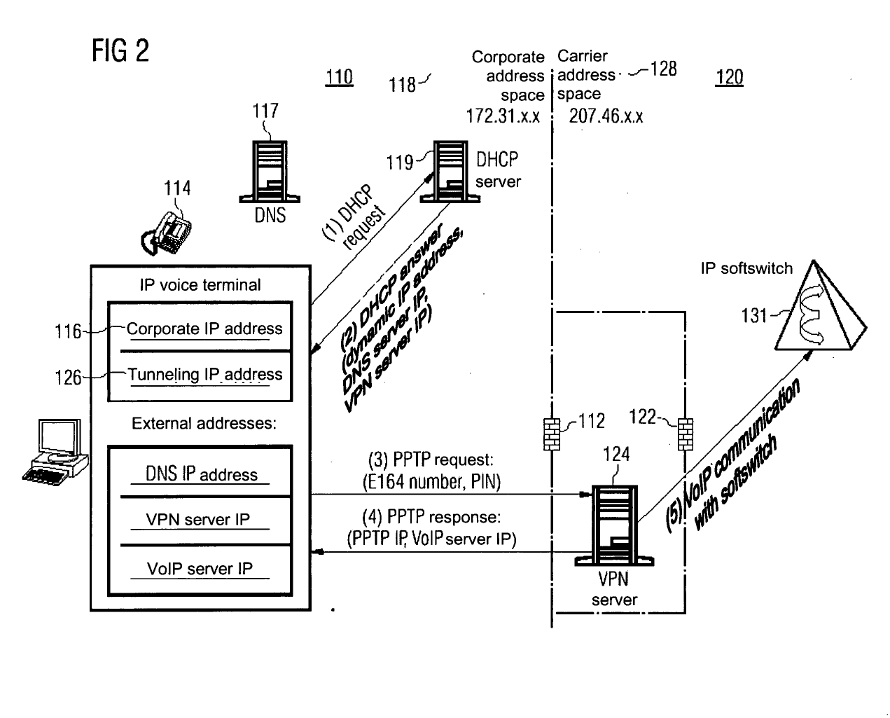

FIG. 2 shows an exemplary registration procedure of a voice terminal.

FIG. 1 is a schematic of a corporate network 110 and a telecoms carrier's network 120 having the components relevant to the present invention. The boundary between the two networks is represented by a dashed line.

The corporate network 110 typically has at least one firewall 112 and one VoIP voice terminal 114. The corporate network can contain further voice terminals and firewalls and other devices and servers (not shown).

The voice terminal 114 is assigned an IP address 116 taken from a first address space 118 (the corporate address space). In the example shown in FIG. 1, the voice terminal 114 is assigned the local IP address 172.31.0.2 belonging to the address space 172.31.x.x.

A further firewall 122 which only routes packets having the addresses of a second address space 128 (carrier address space) is located in the carrier network 120. The carrier address space is formed by the IP addresses 207.46.x.x.

A VPN server 124, shown only by way of example as being integrated in the firewall 122 or, as the case may be, assigned to this, is also located in the carrier network 120. The VPN server 124 can basically be an autonomous component that is independent of the firewall 122, even though its integration into the firewall has the advantage that the VPN connection setup described below is possible with no additional firewall configuring.

A VPN connection 130, also referred to occasionally as a VPN tunnel, is set up between the voice terminal 114 and the VPN server 124. The voice terminal 114 is assigned a further IP address 126 while said VPN connection 130 is being set up, said further IP address being taken from the second address space 128. In the example shown in FIG. 1 this is the IP address 207.46.130.102.

FIG. 2 shows the address issuing process for the VoIP voice terminal 114 with additional details. An IP address from the corporate address space 118 is initially requested in a step (1) by the voice terminal 114 by means of a DHCP request from a DHCP (DHCP: Dynamic Host Configuration Protocol) server in the corporate network 110.

In a step (2), the DHCP server 119 sends a DHCP answer conveying a dynamically assigned IP address, the IP address of a DNS server 117, and the IP address of the VPN server 124 to the voice terminal. The dynamically assigned IP address is the local IP address 116 which is assigned to the voice terminal.

In a step (3), the voice terminal sends identification features to the VPN server 124. Said identification features can comprise a conventional telephone number according to E.164 and a secret number or, as the case may be, PIN. The identification features can alternatively comprise a user ID alongside a PIN, with an assignment of the user ID to a telephone number being stored in a suitable component. The identification features can be entered via the voice terminal keyboard either once only or at the start of each usage session, say at the start of each working day, with automatic logout after 15 minutes of non-use, or at pre-specified times, or they can be stored in a nonvolatile memory belonging to the voice terminal.

Sending of the identification features to the VPN server as a PPTP (PPTP: Point-to-Point Tunneling Protocol) request is shown only by way of example: it is also possible to use other tunneling protocols such as, for example, L2TP (Layer Two Tunneling Protocol).

In a step (4), the VPN server sends a PPTP response containing a PPTP IP address and a VoIP server IP address. The PPTP IP address is assigned to the voice terminal 114 as a further IP address or, as the case may be, tunneling IP address 126. The VoIP server IP address is the IP address of a VoIP server or softswitch performing the call controlling operations. The VoIP server or softswitch corresponds in this case to the remote private automatic branch exchange 131.

In a step (5), unrestricted IP communication which, in particular, is not hindered by the firewall 112 in the corporate network is then possible between the IP voice terminal 114 and the remote private automatic branch exchange 131.

The IP voice terminal was provided with the following data in the course of the registration process: the own IP address 116 from the first address space 118, the further own IP address 126 from the second address space 128, the IP address of the DNS server 117 in the corporate network 110, the IP address of the VPN server 124, and the IP address of the remote private automatic branch exchange 131.

FIG. 2 indicates an arrangement of the VPN server 124 in which, from the viewpoint of the corporate network 110, the VPN server is located behind the firewall 112 of the corporate network but in front of the firewall 122 of the carrier network 120.

FIG. 1 is now considered again. FIG. 1 shows further components of the carrier network. Alongside the remote private automatic branch exchange 131 already explained, a gateway component 132 is shown which facilitates interworking with a conventional circuit-switched telephone network PSTN/ISDN 134.

The conventional telephone network 134 can have switching centers (also referred to as switches) 136, a separate SS7 signaling network 138, signaling transfer points 140, and user terminals 142.

Voice connections to/from the voice terminal 114 are effected by means of the further IP address or, as the case may be, tunneling IP address 126 from the second address space. The VPN connection can be formed on any of the corporate user's IP address spaces. It is only necessary to ensure accessibility of the VPN server in the carrier's network 120. The VPN server is located in, for example, what is termed a perimeter network of the carrier and terminates the VPN connections from the terminal.

Transmission of the traffic to/from the voice terminal from the VPN server to the remote private automatic branch exchange then takes place outside the VPN in the carrier's standard network 120. The VPN connection from the terminal to the VPN server can, as mentioned, be regarded as a tunnel. Depending on the VPN protocol used, said tunnel can also be encrypted. Possible VPN protocols are, as mentioned, L2TP and PPTP. The present invention is not, of course, limited to these exemplary VPN protocols or, as the case may be, tunneling protocols.

Using the VPN tunnels makes it possible to simulate the “security by wire” concept familiar from classical telephone networks (whereby a certain level of security is achieved by assigning all clients and usually all connections their own physical transmission link between the terminal and carrier network).

The invention requires the voice terminal 114 to have means, alongside the known means for VoIP voice communication, for handling the VPN connection 130. Said means comprise, for example, a suitable VPN protocol stack (for VPN clients), encryption means, and means for administering a further IP address 126 exclusively serving the VPN connection 130. The VoIP voice terminal 114 can here support all known VoIP protocols including, for example, H.323, SIP, and MGCP/Megaco.

It is ensured by means of the automatic assignment, described in steps (1) to (4), of all the necessary addresses for the voice terminal 114 that said voice terminal will be ready for use as soon as it has been plugged in and powered on.

If there is a plurality of VPN servers 124 and/or remote private automatic branch exchanges 131 (not shown) in order, for example, to safeguard against single or multiple outages, it will also be possible to send in each case a plurality of IP addresses for VPN servers 124 and/or private automatic branch exchanges 131. Instead of the IP addresses, the voice terminal 114 can alternatively be sent symbolic addresses whose resolution is undertaken by, for example, the DNS server 117. In this case the plurality of IP addresses per symbolic address will be administered by the DNS server, which will then resolve the symbolic address on a “round robin” basis.

As mentioned at the beginning, two methods are known for remote private automatic branch exchanges known as Centrex and hosted PBX. The present invention can also be applied to other services which, for example, simulate the functionality of a private automatic branch exchange for a corporate network.

As indicated in FIG. 1, useful data, which is to say voice information, can be transmitted using, for example, the Real Time Protocol RTP. Signaling information can be transmitted using, for example, the Stream Control Transmission Protocol and Media Gateway Control Protocol SCTP/MGCP.

1.-11. (cancelled)

12. A method for operating a voice terminal connected to a remote private automatic branch exchange, wherein
communication between the voice terminal and the remote private automatic branch exchange takes place using the IP Internet Protocol, wherein
the voice terminal is assigned to a subnetwork having a first IP address space, wherein
the remote private automatic branch exchange operates in a second IP address space, and wherein
IP addresses of the first IP address space are not valid in the second IP address space, the method comprising:
(a) determining an IP address from the first address space for the voice terminal;
(b) determining a VPN server for the voice terminal;
(c) setting up a VPN connection between the voice terminal and the VPN server with assigning of a further IP address, taken from the second IP address space, by the VPN server; and
(d) exchanging information and/or signaling information between the voice terminal and the remote private automatic branch exchange via the VPN connection by the VPN server.

13. A method according to claim 12, wherein the information transmission of the VPN connection is encrypted.

14. A method according to claim 12, wherein the VPN connection is carried out using the Layer Two Tunneling Protocol L2TP or Point-to-Point Tunneling Protocol PPTP.

15. A method according to claim 13, wherein the VPN connection is carried out using the Layer Two Tunneling Protocol L2TP or Point-to-Point Tunneling Protocol PPTP.

16. A method according to claim 12, wherein communication between the voice terminal and the remote private automatic branch exchange takes place using one of the following protocols: ITU-T H.323, Session Initiation Protocol SIP, or Media Gateway Control Protocol MGCP/Megaco.

17. A method according to claim 13, wherein communication between the voice terminal and the remote private automatic branch exchange takes place using one of the following protocols: ITU-T H.323, Session Initiation Protocol SIP, or Media Gateway Control Protocol MGCP/Megaco.

18. A method according to claim 14, wherein communication between the voice terminal and the remote private automatic branch exchange takes place using one of the following protocols: ITU-T H.323, Session Initiation Protocol SIP, or Media Gateway Control Protocol MGCP/Megaco.

19. A method according to claim 12, wherein the remote private automatic branch exchange is embodied as a Centrex system or hosted PBX.

20. A method according to claim 13, wherein the remote private automatic branch exchange is embodied as a Centrex system or hosted PBX.

21. A method according to claim 14, wherein the remote private automatic branch exchange is embodied as a Centrex system or hosted PBX.

22. A method according to claim 16, wherein the remote private automatic branch exchange is embodied as a Centrex system or hosted PBX.

23. A communication arrangement, comprising:
a voice terminal; and
a remote private automatic branch exchange, wherein
communication between the voice terminal and the remote private automatic branch exchange takes place using the IP Internet Protocol, wherein
the voice terminal is assigned to a subnetwork having a first IP address space, wherein
the remote private automatic branch exchange is assigned to a network having a second IP address space, wherein
IP addresses of the first IP address space are not valid in the second IP address space; wherein
a VPN connection between the voice terminal and the network to which the remote private automatic branch exchange is assigned, and wherein
communication between the voice terminal and the remote private automatic branch exchange takes place via the VPN connection.

24. A communication arrangement according to claim 23, wherein the VPN connection is an encrypted VPN connection.

25. A communication arrangement according to claim 23, wherein the VPN connection is carried out using the Layer Two Tunneling Protocol L2TP or Point-to-Point Tunneling Protocol PPTP.

26. A communication arrangement according to claim 23, wherein communication between the voice terminal and the remote private automatic branch exchange takes place using one of the following protocols: ITU-T H.323, Session Initiation Protocol SIP, or Media Gateway Control Protocol MGCP/Megaco.

27. A communication arrangement according to claim 23, wherein the remote private automatic branch exchange is embodied as a Centrex system or hosted PBX.

28. A voice terminal for connecting to a remote private automatic branch exchange, comprising:
a mechanism for transmitting and receiving useful information and signaling information using the IP Internet Protocol;
a mechanism for receiving an own IP address of a first IP address space;
a mechanism for carrying out IP communication employing the own IP address of the first address space;
a mechanism for determining an IP address of a VPN server;
a mechanism for setting up a VPN connection to the VPN server; and
a mechanism for receiving a further own IP address from a second IP address space and an IP address of the remote private automatic branch exchange.
